(19) United States
(12) Patent Application Publication
(10) Pub. No.: US 2012/0155077 A1
(43) Pub. Date: Jun. 21, 2012

(54) LIGHT EMITTING DIODE FLOODLIGHT

(75) Inventors: Sang Ok KIM, Seoul (KR); Byung Oh KIM, Suwon (KR); Min Jin CHO, Suwon (KR); In Su LEE, Hwaseong (KR)

(73) Assignee: YUYANG DNU CO., LTD., Hwaseong-si (KR)

(21) Appl. No.: 13/038,780

(22) Filed: Mar. 2, 2011

(30) Foreign Application Priority Data
Dec. 17, 2010 (KR) 10-2010-0129682

(51) Int. Cl. F21V 29/00; F21V 21/00; F21V 13/02

(52) U.S. Cl. 362/235

(57) ABSTRACT

A light emitting diode floodlight includes a hollow housing, a lens, a cover, a light source, an illumination reflector, an intermediate portion, and a power source. The cover is coupled to the end of the housing and configured to hold and support the lens. The light source has a pyramidal frustum-shaped portion installed at an opposite end of the housing. The illumination reflector is installed within the housing so as to surround a periphery of the pyramidal frustum-shaped portion of the light source. The intermediate portion is connected to a first heat sink of the light source and has a second heat sink on an outer peripheral surface thereof. The power source has a power supply electrically connected to the light source.

### CROSS-REFERENCE TO RELATED APPLICATION

This application claims the priority of Korean Patent Application No. 10-2010-0129682, filed on Dec. 17, 2010 in the Korean Intellectual Property Office, the disclosure of which is incorporated herein in their entirety by reference.

### TECHNICAL FIELD

The present disclosure relates to a light emitting diode (LED) floodlight. More particularly, the present disclosure relates to an LED floodlight for the focused illumination of desired areas by a three-dimensional light source arrangement and a high-intensity illumination reflector.

### BACKGROUND OF THE DISCLOSURE

The statements in this section merely provide background information related to the present disclosure and may not constitute prior art.

Floodlights are generally installed indoors or outdoors for irradiating desired illuminations to building structures, gigantic monuments, stadiums, plant equipments, and industrial facilities.

These floodlights are made by using mainly high illumination discharge lamps and including light projecting surfaces of glass or acryl with an excellent transparency, and are installed wherever available at appropriate intervals to high columns or walls for the optimal positions towards the highest illuminating efficiency possible to illuminate areas below.

However, since the conventional floodlights utilize metal halide lamps, sodium lamps, or halogen lamps for their light sources, drawbacks of these sources are reflected in the form of high consumption of electricity, short operating life, slow lighting start, steep maintenance cost, and especially pollution of environment.

Therefore, in view of the low electricity consumption and the semi-permanent lifetimes, LEDs are increasingly applied to the light sources for the sake of illumination enhancement and saving of energy. However, LED floodlights characteristically project lights perpendicularly to the mounting surfaces of the LEDs rendering the floodlights to have a limited radiation angle.

Moreover, even if it is a requirement for an industrial floodlight being capable of intensely illuminating a target area, uneven distribution of the intensity of illumination lowers the average intensity failing to concentrate light with the center of the illuminated area which falls short of achieving the purpose and the effect of the lighting installation.

### DISCLOSURE OF THE INVENTION

Therefore, the present disclosure has been made in an effort to provide an LED floodlight, which can be promptly turned on, can be semi-permanent, can save energy remarkably, and can transfer light accurately to a desired illumination region by enhancing a light concentrating effect and an illumination intensity of a central region.

One aspect of the present disclosure provides an LED floodlight including a hollow housing, a lens, a cover, a light source, an illumination reflector, an intermediate portion, and a power source. The lens is provided at one end of the housing. The cover is coupled to the end of the housing and configured to hold and support the lens. The light source has a pyramidal frustum-shaped portion installed at an opposite end of the housing and accommodated within the housing. A plurality of PCBs are mounted onto the pyramidal frustum-shaped portion and a plurality of LEDs are arranged on and mounted to the PCBs. A first heat sink is exposed to the outside of the housing on an opposite side of the pyramidal frustum-shaped portion. The illumination reflector is installed within the housing so as to surround a periphery of the pyramidal frustum-shaped portion of the light source. The intermediate portion is connected to the first heat sink of the light source and has a second heat sink on an outer peripheral surface thereof. The power source has a power supply electrically connected to the PCBs of the light source.

According to the disclosure as described above, an LED floodlight can provide a focused illumination of desired areas by a three-dimensional light source arrangement and a high-intensity illumination reflector. Therefore, the disclosed LED floodlight can accurately transmit light to a desired illumination region by focusing the light and enhancing the illumination intensity of the focused region. Also, the LED floodlight can be promptly turned on, can be semi-permanently used, can save energy remarkably, and can be applied to an illumination apparatus requiring a specific condition as in industrial facilities.

### BRIEF DESCRIPTION OF THE DRAWINGS

The above and other objects, features and advantages of the present disclosure will be more apparent from the following detailed description taken in conjunction with the accompanying drawings, in which:

FIG. 1 is a perspective view of an LED floodlight according to an aspect of the present disclosure;

FIG. 2 is a sectional view of the LED floodlight of FIG. 1;

FIG. 3 is a plan view of the LED floodlight of FIG. 1;

FIG. 4 is an exploded perspective view of the LED floodlight of FIG. 1; and

FIG. 5 is a light distribution curve of the LED floodlight according to the aspect of the present disclosure.

### DETAILED DESCRIPTION OF THE EXEMPLARY EMBODIMENTS

Hereinafter, an exemplary embodiment of the present disclosure will be described with reference to the accompanying drawings. In the following description, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

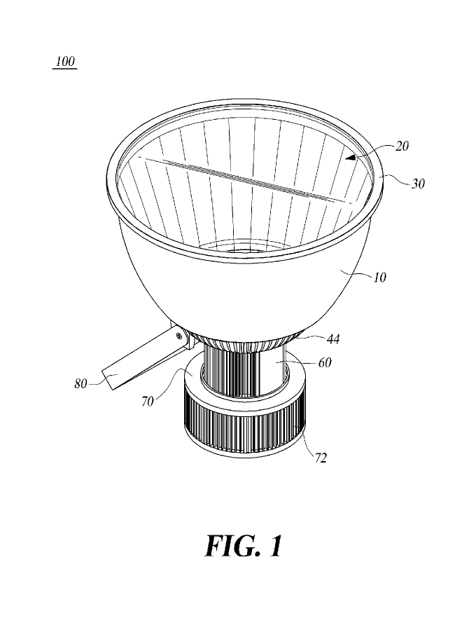

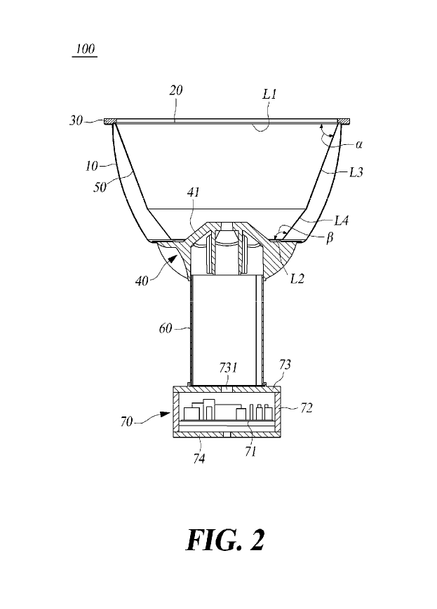

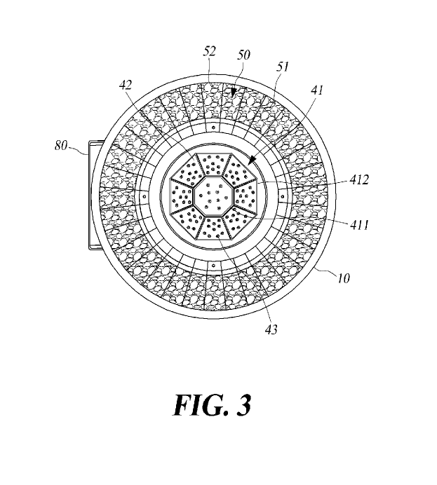

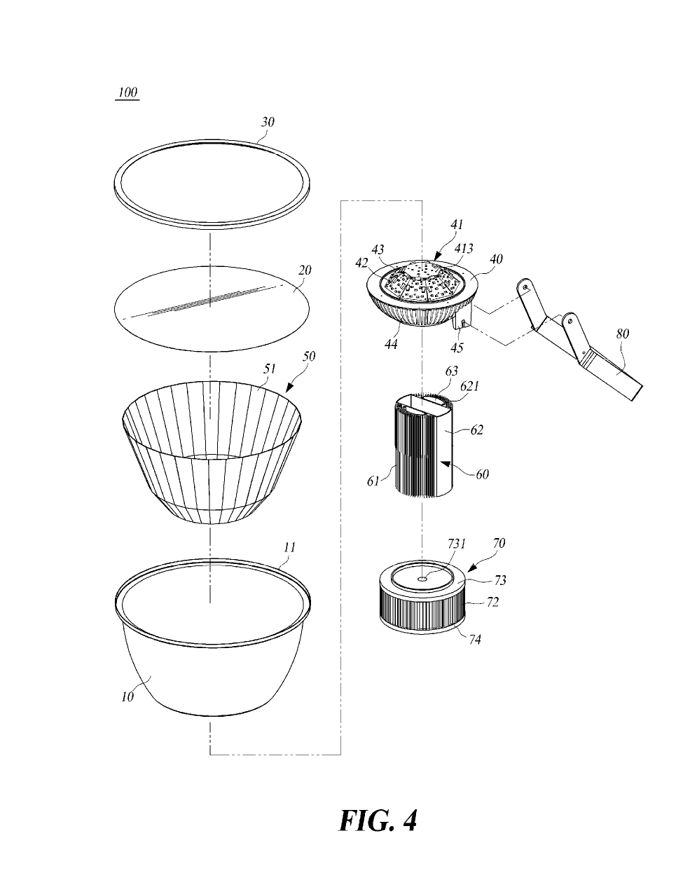

FIG. 1 is a perspective view of an LED floodlight, FIG. 2 its sectional view, FIG. 3 its plan view, and FIG. 4 is an exploded view of the LED floodlight according to an aspect of the disclosure.

As shown in the figures, the LED floodlight 100 according to the embodiment of the present disclosure includes a hollow housing 10; a lens 20 provided at one end of the housing 10; a cover 30 coupled to the end of the housing 10 and configured to hold and support the lens 20; a light source 40 having a pyramidal frustum-shaped portion installed at an opposite end of the housing 10 and accommodated within the housing 10, a plurality of PCBs 42 mounted onto the pyramidal frustum-shaped portion 41, a plurality of LEDs 43 arranged on and mounted to the PCBs 42, and a first heat sink 44 exposed to the outside of the housing 10 on an opposite side of the pyramidal frustum-shaped portion 41; an illumination reflector 50 installed within the housing 51 so as to surround a periphery of the pyramidal frustum-shaped portion 41 of the light source 40; an intermediate portion 60 connected to the first heat sink 44 of the light source 40 and having a second heat sink 61 on an outer peripheral surface thereof; and a power source 70 connected to the intermediate portion 60 on an opposite side of the light source 40 and having a power supply 71 housed inside and a third heat sink 72 formed on an outer peripheral surface thereof.

The housing 10 is a substantially hollow cylindrical member which is made of a metallic material, such as aluminum, and whose diameter on one side is larger than a diameter on the opposite side. A stepped peripheral portion 11 is formed at one end of the housing 10 having a relatively large diameter.

The lens 20 is a circular plate member made of transparent glass and is positioned in the step formed at the peripheral portion 11 of the housing 10.

The cover 30 covers an end of the lens 20 and is coupled to the peripheral portion 11 of the housing 10. The cover 30 may be coupled to the peripheral portion 11 using coupling clips or fixing screws (not shown). A rubber packing (not shown) is interposed between the cover 30 and the lens 20 or between the lens 20 and the peripheral portion 11 to enhance a water-proof performance.

The light source 40 is located on an opposite end of the housing 10. The light source 40 is made of a thermally conductive metal such as aluminum. A pyramidal frustum-shaped portion 41 has a polygonal upper surface 411 located at the center thereof and a plurality of trapezoidal inclined surfaces 412 extending from edges of the polygonal upper surface 411 so as to protrude from one side of the light source 40. The opposite side of the light source 40 has a substantially semi-spherical shape and a plurality of fins is formed on an outer peripheral surface of the semi-spherical portion of the light source 40, constituting a first heat sink 44. The housing 10 may be fixed to the pyramidal frustum-shaped portion 41 by fixing screws, and a rubber packing (not shown) is interposed between the housing 10 and the light source 40 to enhance a water-proof performance.

A bracket 45 configured to couple a connecting member 80 for installing the LED floodlight 100 on a column or a wall is formed on the opposite side of the light source 40. The bracket 45 and the connecting member 80 may be coupled to each other using bolts.

Although FIG. 3 illustrates an embodiment where the pyramidal frustum-shaped portion 41 is an eight-sided pyramidal frustum, its shape is not limited thereto but may be any other pyramidal frustum having a different number of sides.

An angle between the polygonal upper surface 411 and the trapezoidal inclined surfaces 412 of the pyramidal frustum-shaped portion 41 is within a range of approximately 120 to 150 degrees, and more preferably within approximately 140 to 141 degrees. The LEDs 43 are arranged on the pyramidal frustum-shaped portion 41 in 3D to solve a conventional problem where illumination intensities are not uniformly distributed as light becomes insufficient when it becomes far away from the center of the illumination region in the case of planar arrangement of LEDs. In particular, as the brightness at the center or the periphery of the illumination region is uniformly formed within the above-described angle range, illumination efficiency can be increased.

A plurality of PCBs 42 made of a thermally conductive metallic material are mounted to the pyramidal frustum-shaped portion 41 in correspondence to the shapes of the polygonal upper surface 411 and the trapezoidal inclined surfaces 412. A plurality of LEDs 43 are arranged on and mounted to the PCBs 42. The PCBs 42 may be fixed to the pyramidal frustum-shaped portion 41 using fixing screws, and a rubber packing (not shown) may be interposed between the PCBs 42 and a surface of the pyramidal frustum-shaped portion 41 to enhance heat absorbing and water-proof performances.

The illumination reflector 50 is a hollow member which is similar to the housing 10 and has a shape whose diameter at one side is larger than a diameter at an opposite side so as to be widened. The illumination reflector 50 is installed within the housing 10 so as to surround a periphery of the pyramidal frustum-shaped portion 41 of the light source 40 accommodated within the housing 10. The illumination reflector 50 may be fixed to the pyramidal frustum-shaped portion 41 of the light source 40 inside the housing 10 using fixing screws. The illumination reflector 50 may have a pyramidal frustum shape where a plurality of trapezoidal portions 51 are connected, and preferably has thirty two or more trapezoidal portions 51, that is, is a more than thirty two sided pyramidal frustum. The illumination reflector 50 is fabricated by polishing and glossing a metal plate of aluminum, by special coating, or by bonding a film where silver or aluminum is deposited to a metal plate.

As shown in FIG. 2, the illumination reflector 50 has an inclined side edge connecting one end (L1) of a large diameter and an opposite end L2 of a small diameter. The inclined side edge is bent at an intermediate portion thereof so as to have a first edge (L3) connecting the end (L1) to the bent portion and a second edge (L4) connecting the opposite end (L2) to the bent portion. Then, an angle (α) between a plane formed by the end (L1) and the first edge (L3) is within a range of 65 to 75 degrees, and preferably within 69 to 70 degrees. Also, an angle (β) between a plane formed by the opposite end (L2) and the second edge (L4) is within a range of 122 to 132 degrees, and preferably 127 to 128 degrees. The light generated by the LEDs 43 gathers to the center, enhancing the illumination intensity of the center of the illumination region within an optimization range of the inclined angle of the side edge of the illumination reflector 50 which has been determined, considering the reflection angle of light. Although FIG. 2 illustrates a shape of the illumination reflector 50 bent once, the present disclosure is not limited to it but the illumination reflector 50 may be bent twice or more so that the angle between the end and the edge of the illumination reflector 50 may be modified according to an optimum illumination intensity.

As shown in FIG. 3 in detail, the illumination reflector 50 may have bosses 52 regularly or irregularly formed on a surface of the inner peripheral surface thereof, and more particularly on a surface extending from one end L1 to the bent portion, in which case the bosses 52 cause scattered reflection of light, enhancing uniformity ratio of the illuminated area.

As a result, in the LED floodlight 100 according to the embodiment of the present disclosure, an illumination effect that can satisfy requirements in a special environment such as an industrial facility can be performed by arranging the LEDs 43 in 3D and optimizing the inclination angle of the illumination reflector 50.

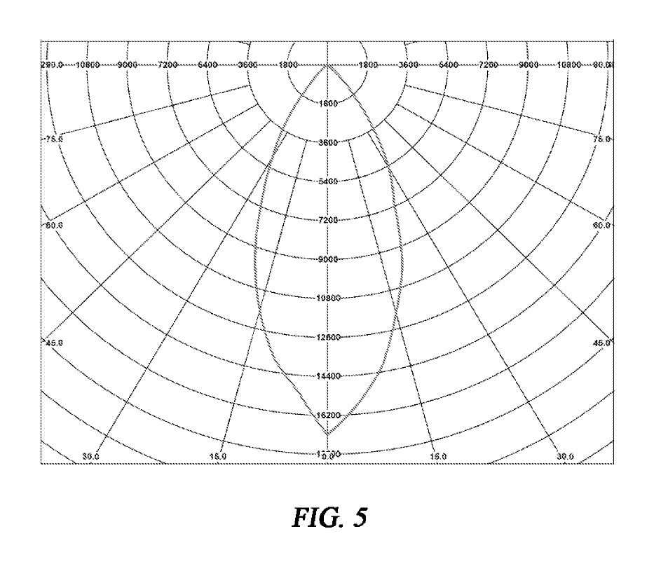

FIG. 5 is a light distribution curve of the LED floodlight according to the embodiment of the present disclosure. As shown in FIG. 5, it can be seen from the light distribution curve that intensity of illumination is concentrated at the center of the illumination range by arranging the LEDs 43 in 3D and optimizing the inclination angle of the illumination reflector 50. That is, light is irradiated to the center without deviating from an angle of 45 degrees but within a range of 20 to 25 degrees.

The intermediate portion 60 includes a hollow support pipe 62, a pair of heat radiating portions 63 integrally formed at opposite sides of the support pipe 62 and having a semicircular cross-section, and second heat sinks 61 formed on an outer peripheral surface of the heat radiating portions 63 and having the shape of fins. One side of the intermediate portion 60 is connected to the first heat sink 44 of the light source 40. A plurality of connecting holes 413 are formed on a polygonal surface 411 of the pyramidal frustum-shaped portion 41 or in the PCB 42 mounted thereon and a plurality of screw holes 621 are formed on one side of the support pipe 62 of the intermediate portion 60, in which case the light source 40 and the intermediate portion 60 can be coupled to each other using a plurality of thin and long screws (not shown). The hollow support pipe 62 serves as a passage through which a wire (not shown) for supplying power to the LEDs 43 can pass. The second heat sinks 61 occupy almost all portions of the intermediate portions 60 and are formed from a thermally conductive material such as aluminum to maximize a heat radiating effect.

The power source 70 is coupled to an opposite side of the intermediate portion 60. The hollow body 73 constituting the power source 70 is made of a thermally conductive material such as aluminum and a third heat sink 72 having a plurality of fins is provided on an outer peripheral surface of the body 73, which helps heat radiation of the entire apparatus. A through-hole 731 through which the above-mentioned wire passes is formed on one side of the body 73 and a plurality of connecting holes (not shown) are formed around the through-hole 731. A rubber packing (not shown) is interposed between the power source 70 and the intermediate portion 60 to enhance heat absorbing and water-proof performances.

A power supply 71 is provided within the body 73 of the power source 70 to convert an AC power of a common high voltage (110 to 220 V) to a DC power of a low voltage (for example, approximately 5 V) by using an adapter or a switching mode power supply (SMPS). The power supply 71 may supply electric power to the LEDs 43 through the PCB 42 in the light source 40 by means of a wire.

A separable cover 74 is provided at an opposite side of the body 73, in which case the interior of the body 73 may be opened to connect the power source 70 and the intermediate portion 60 using screws, connect a wire extending from the light source 40 and the power supply 71, and maintain the power supply 71. The cover 74 may be fixed to the body 73 of the power source 70 using fixing screws.

Although the power source 70 is integrally assembled in the LED floodlight 100 according to the embodiment of the present disclosure in the figures, the present disclosure is not limited thereto, but only the power source 70 may be installed to be spaced apart from the intermediate portion 60 by a certain distance. In this case, a wire extends from the power supply 71 of the power source 70 and penetrates a separate cover plate (not shown) provided on an opposite side of the intermediate portion 60 and the support pipe 62 to be electrically connected to the PCB 42 provided in the light source 40 so as to supply electric power to the LEDs 43.

According to the LED floodlight of the present disclosure, LEDs are used as light sources and are arranged in 3D and an inclination angle of an illumination reflector is optimized. Also, a plurality of heat sinks made of a thermally conductive metal is used. Accordingly, power consumption can be reduced and the life of the LED floodlight can be prolonged. Also, not only the center of an illumination region but also a periphery thereof can be widely lit at a high brightness. Further, it can be easily maintained, so its management efficiency can be enhanced.

Although exemplary embodiments of the present disclosure have been described for illustrative purposes, those skilled in the art will appreciate that various modifications, additions and substitutions are possible, without departing from the scope of the disclosure. Therefore, exemplary embodiments have not been described for limiting purposes. Accordingly, the scope of the disclosure is not to be limited by the above embodiments but by the claims and the equivalents thereof.

What is claimed is:

1. A light emitting diode floodlight, comprising:
a hollow housing;
a lens provided at one end of the housing;
a cover coupled to the end of the housing and configured to hold and support the lens;
a light source having a pyramidal frustum-shaped portion installed at an opposite end of the housing and accommodated within the housing, a plurality of PCBs mounted onto the pyramidal frustum-shaped portion, a plurality of light emitting diodes arranged on and mounted to the PCBs, and a first heat sink exposed to the outside of the housing on an opposite side of the pyramidal frustum-shaped portion;
an illumination reflector installed within the housing so as to surround a periphery of the pyramidal frustum-shaped portion of the light source;
an intermediate portion connected to the first heat sink of the light source and having a second heat sink on an outer peripheral surface thereof; and
a power source having a power supply electrically connected to the PCBs of the light source.

2. The light emitting diode floodlight as claimed in claim 1, wherein the power source is connected to the intermediate portion on an opposite side of the light source.

3. The light emitting diode floodlight as claimed in claim 2, wherein the power source includes a hollow body, a third heat sink formed on an outer peripheral surface of the body, a power supply installed within the body, and a cover separably provided on an opposite side of the intermediate portion.

4. The light emitting diode floodlight as claimed in claim 1, wherein the pyramidal frustum-shaped portion includes a polygonal upper surface located at the center thereof and a plurality of trapezoidal inclined surfaces extending from edges of the polygonal upper surface while being inclined, and protrudes from one side of the light source.

5. The light emitting diode floodlight as claimed in claim 4, wherein a bracket configured to couple a connecting member for installing the light emitting diode floodlight on a column or a wall is provided on the opposite side of the light source.

6. The light emitting diode floodlight as claimed in claim 4, wherein an angle between the polygonal upper surface and the trapezoidal inclined surfaces of the pyramidal frustum-shaped portion is within a range of 120 to 150 degrees.

7. The light emitting diode floodlight as claimed in claim 6, wherein when the illumination reflector has an inclined side edge connecting one end (L1) of a large diameter and an opposite end L2 of a small diameter and the inclined side edge is bent at an intermediate portion thereof so as to have a first edge (L3) connecting the end (L1) to the bent portion and a second edge (L4) connecting the opposite end (L2) to the bent portion, an angle (α) between a plane formed by the end (L1) and the first edge (L3) is within a range of 65 to 75 degrees and an angle (β) between a plane formed by the opposite end (L2) and the second edge (L4) is within a range of 122 to 132 degrees.

8. The light emitting diode floodlight as claimed in claim 1, wherein the illumination reflector has bosses regularly or irregularly formed on an inner peripheral surface.

9. The light emitting diode floodlight as claimed in claim 1, wherein the intermediate portion includes a hollow support pipe, a pair of heat radiating portions integrally formed at opposite sides of the support pipe and having a semicircular cross-section, and second heat sinks each being formed on an outer peripheral surface of the corresponding heat radiating portion.
